(19) United States
(12) Patent Application Publication
(10) Pub. No.: US 2009/0212991 A1
(43) Pub. Date: Aug. 27, 2009

(54) Systems and methods of providing whisper shout surveillance with a TCAS

(76) Inventors: Mark D. Smith, Glendale, AZ (US); Lyle A. Fajen, Scottsdale, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/786,986

(22) Filed: Apr. 10, 2007

Related U.S. Application Data
(60) Provisional application No. 60/790,924, filed on Apr. 10, 2006.

(51) Int. Cl. G01S 13/93

(52) U.S. Cl. 342/29

(57) ABSTRACT

A collision avoidance system is delineated comprising a TCAS transmitter having a feed forward path with a plurality amplifiers for providing to a TCAS transmitter output a TCAS transmitter output transmission, a feedback path coupled to the TCAS transmitter output for providing a feedback signal, and a controller for receiving the feedback signal and generating control signals for providing to one or more of the plurality of amplifiers for controlling the respective outputs of the one or more amplifiers to drive the TCAS transmitter output transmission to a predefined level.

### CROSS REFERENCE TO RELATED APPLICATIONS

This application is related to and claims priority from U.S. Appl. No. 60/790,924, filed Apr. 10, 2006 and entitled “SYSTEM AND METHOD OF PROVIDING WHISPER SHOUT SURVEILLANCE IN TCAS,” the foregoing related application being incorporated herein by reference.

### BACKGROUND OF THE INVENTION

1. Field of the Invention

The present invention relates to avionics systems, and more particularly, to systems and methods of providing whisper shout surveillance with a Traffic alert and Collision Avoidance System (TCAS).

2. Description of the Related Art

The whisper shout attenuation function of a TCAS is intended to provide some selectivity as to which transponder-equipped aircraft respond to TCAS interrogations. The whisper shout attenuation changes the transmitted output power level from the TCAS. The TCAS interrogates close aircraft first, and increases its range incrementally in range rings about the aircraft. This is accomplished by sending out suppression pulses ahead of the interrogation that are slightly lower in amplitude than the interrogation. If the suppression pulses are high enough in amplitude to be detected by the intruder's transponder, the transponder doesn't reply to the TCAS interrogation. At each successive increase in power by decreasing the whisper shout attenuation, the transmission range increases and new aircraft are interrogated while previously-contacted aircraft cease to respond. This accomplishes a reduction in the number of RF replies in the environment to avoid excessive RF replies (known as RF pollution).

The TCAS specification, known as DO-185A, entitled “Minimum Operational Performance Standards for Traffic Alert and Collision Avoidance System (TCAS) Airborne Equipment” and published by RTCA (the Radio Technical Commission for Aeronautics), requires power output at the back of the TCAS unit to be on the order of 500 Watts. Past generation TCAS transmitters have relied on bipolar transistor technology to achieve such power levels at the desired frequency, because better technologies had not yet been developed to economically accomplish the same function. Since high power bipolar amplification stages operate in class C (saturation), they essentially output at maximum power during the entire time that they are enabled. In the past, to achieve the precision power output control required by a TCAS, attenuators had to follow the high power amplifiers in order to attenuate the output signal to the desired level. These attenuators typically comprise a plurality of resistors in a pi formation to provide the attenuation function and PIN (P-type, Intrinsic, N-Type) diodes to switch the attenuator in or out of the transmit path. A block diagram of an exemplary TCAS transmitter and whisper shout attenuator is shown in FIG. 1, and an exemplary attenuator is shown in FIG. 2, both examples coming from the TCAS 2000 product from Aviation Communication & Surveillance Systems, Inc. (ACSS).

FIG. 1 shows that the TCAS transmitter actually generates approximately 1000 Watts at peak output power when the two 500 Watt transistor outputs are added. This power is then routed through the whisper shout precision attenuator where excess power is absorbed to achieve the desired output power to be transmitted from the unit. A TCAS must be able to transmit at least 27 different levels of output power, assuming the TCAS is a TCAS II unit, however, those skilled in the art understand that various other collision avoidance systems, such as a TCAS I, may require a different number of stepped power levels for whisper shout operation. To accomplish this system requirement, the system switches in or out each of the attenuator blocks in the whisper shout attenuator circuit to achieve the desired overall attenuation.

FIG. 2 shows an example of a resistive attenuator used in the TCAS 2000 product from ACSS. The RF input is either routed through the resistor network which must be calibrated to provide the precise attenuation required, or through a direct path with no or negligible attenuation. PIN diodes are used to control which path the RF signal is routed through. In the TCAS 2000 product, the only attenuator that does not follow the convention of FIG. 2 is the 0.5 dB attenuator, which is simply a shunt resistor to ground that is switched in or out of the path by a PIN diode circuit.

One problem with current TCAS transmitters is that the power level generated by the TCAS transmitter is significantly higher than the desired output transmission, particularly for lower level whisper shout interrogations. The excess power is dissipated as heat in the attenuators, thereby wasting energy and degrading system efficiency. Additionally, the resistors currently used in TCAS whisper shout attenuators must be capable of absorbing large power levels, and are therefore, more expensive than typical resistors. Moreover, the cost of the PIN diodes and their driver circuitry is significant, raising the cost of current TCAS. Finally, the space that is required to host the resistors, PIN diodes and driver circuitry, as found in current TCAS transmitters, increases product cost.

U.S. Pat. Nos. 5,109,204 and 6,144,265 to ACSS describe mechanisms for precisely controlling attenuation levels for high power RF signals. FIGS. 1 and 2 of the present application are typical of the design represented in U.S. Pat. No. 6,144,265. Other methods exist to address the requirements of whisper shout in a TCAS, but these methods have generally included means of absorbing the power after it has already been generated.

Thus, a need exists for systems and methods of providing whisper shout surveillance with a TCAS, which overcome these and other problems.

### SUMMARY OF THE INVENTION

In accordance with an embodiment of the present invention, a collision avoidance system is disclosed comprising a TCAS transmitter having a feed forward path with a plurality of amplifiers for providing to a TCAS transmitter output a TCAS transmitter output transmission, a feedback path coupled to the TCAS transmitter output for providing a feedback signal, and a controller for receiving the feedback signal and generating control signals for providing to one or more of the plurality of amplifiers for controlling the respective outputs of the one or more amplifiers to drive the TCAS transmitter output transmission to a predefined level.

In accordance with another embodiment of the present invention, a method of operating a TCAS for a whisper shout operation is disclosed comprising providing signals to bias a plurality of amplifiers to provide on a TCAS transmitter output a TCAS transmission of a predefined power level for whisper shout operation; and adjusting the signals for biasing the plurality of amplifiers based on a measurement of the predefined power level for whisper shout operation.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is a block diagram of a TCAS transmitter and whisper shout attenuator, consistent with the prior art.

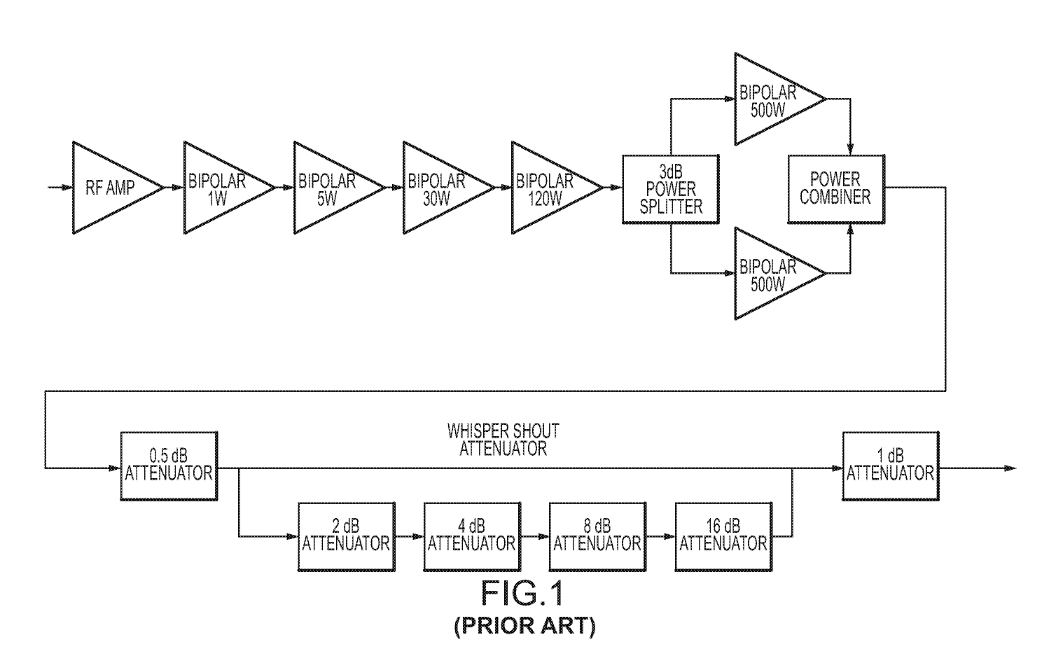

FIG. 2 is a schematic diagram of a resistive attenuator that may be utilized for attenuators in the whisper shout attenuator of FIG. 1.

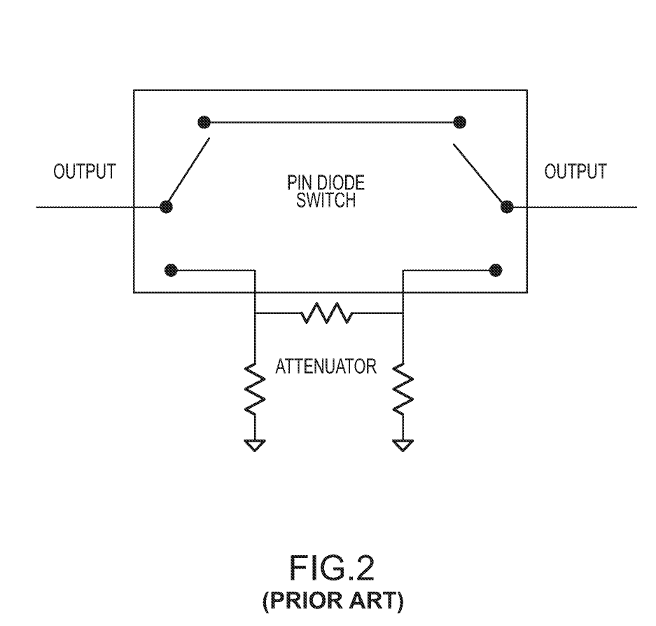

FIG. 3 is a block diagram of an embodiment of a TCAS transmitter, in accordance with systems and methods consistent with the present invention.

FIG. 4 is a plot of power out as a function of Vgs for a transistor that may be employed in a TCAS transmitter, in accordance with systems and methods consistent with the present invention.

FIG. 5 is a block diagram of an embodiment of a TCAS transmitter, in accordance with systems and methods consistent with the present invention.

FIG. 6 is a block diagram of an embodiment of a process for initializing a TCAS transmitter, in accordance with systems and methods consistent with the present invention.

FIG. 7 is a table of initial calibration data for use with a TCAS transmitter, in accordance with systems and methods consistent with the present invention.

FIG. 8 is a table of working data for use with a TCAS transmitter, in accordance with systems and methods consistent with the present invention.

FIG. 9 is a block diagram of an embodiment of a process for selecting output power for a TCAS transmitter, in accordance with systems and methods consistent with the present invention.

FIG. 10 is a block diagram of an embodiment of a process for compensating output power for a TCAS transmitter, in accordance with systems and methods consistent with the present invention.

FIG. 11 is a block diagram of an embodiment of a TCAS transmitter, in accordance with systems and methods consistent with the present invention.

### DESCRIPTION OF THE EMBODIMENTS

Reference will now be made in detail to the present exemplary embodiments of the invention, examples of which are illustrated in the accompanying drawings.

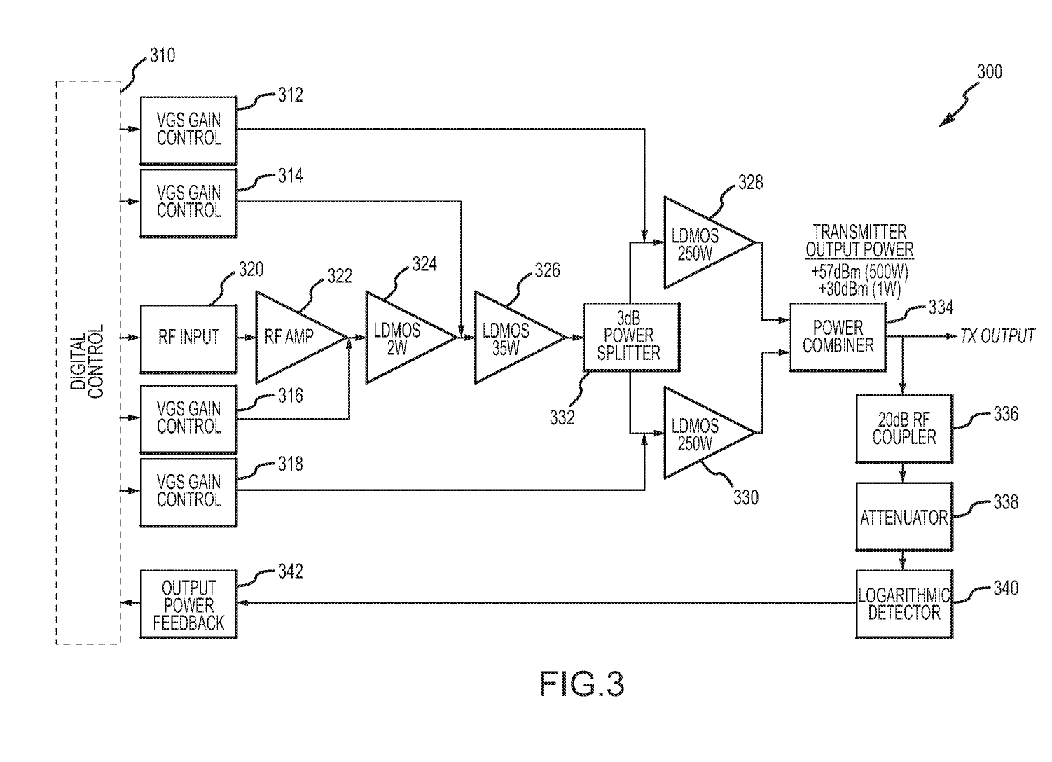

FIG. 3 shows a block diagram of one embodiment of a TCAS transmitter 300, consistent with systems and methods of the present invention. TCAS transmitter 300 may include digital control circuitry 310, Vgs gain controllers 312-318, an RF input 320, an RF amplifier 322, high power amplifiers 324-330, a power splitter 332, a power combiner 334, an RF coupler 336, an attenuator 338, a logarithmic detector 340 and an output power feedback system 342.

In this embodiment of TCAS transmitter 300, high power amplifiers 324-330 may be based on technology that is designed to operate in the class AB mode, such as LDMOS (Laterally Diffused Metal Oxide Semiconductor) technology, thus offering much better linearity than the bipolar technology utilized in prior TCAS transmitters. An input signal is provided to RF input 320. RF input 320 may comprise any circuitry for providing a low power signal at a desired operational frequency. RF amplifier 322 may comprise any circuitry for amplifying the output from RF input 320 to an input level required for amplifier 324. Generally, the maximum power output available today with LDMOS amplifiers is on the order of 250 Watts. As new high power amplifiers become available, they may be implemented.

Although many amplification schemes exist or may be envisioned by one with ordinary skill in the art, one exemplary scheme is shown in FIG. 3 for purposes of description. After passing through RF input 320 and RF amplifier 322, the signal passes through two linear high power amplifiers 324 and 326 before being split by power splitter 332 into two paths, each passing through a respective high power linear amplifier 328 and 300. The outputs of amplifiers 328 and 330 are combined by power combiner 334 to provide a TCAS transmitter output.

TCAS transmitter 300 may provide any desired TCAS output transmission, such as may be required by the whisper shout scheme. Additionally, the TCAS transmitter output is fed back to improve system performance. Employing such feedback enables precise power control such that TCAS transmitter 300 does not have to overdrive and waste power, as was the norm for prior TCAS transmitters.

Any desired feedback scheme may be employed, however, in this exemplary embodiment, the transmitter output is fed back through a 20 dB RF coupler 336, an attenuator 338, a logarithmic detector 340 and an output power feedback system 342. After the outputs of the final high power transistors 328 and 330 have been combined to provide a desired output power level, the amplitude of the output power is sampled and provided to logarithmic detector 340. Any circuit that converts an RF signal to a DC voltage output that is linearly proportional to the RF signal may be used, such as logarithmic detector 340. Prior to logarithmic detector 340, an RF coupler 336 is employed to couple a portion of the output signal that is then passed through an attenuator 338 to translate the input RF signal to a level desired by logarithmic detector 340.

Digital control circuitry 310 receives signals from output power feedback system 342 indicative of the transmitter output. These signals are employed by digital control circuitry 310 to provide control inputs to the various Vgs controllers 312-318, which, in turn, control high power amplifiers 328, 326, 324 and 330, respectively.

For example, each high power amplifier 324-330 may have its own gain control input that may be controlled by digital control circuitry 310. The output of logarithmic detector 340 may be converted by output power feedback system 342 from a DC voltage to data, such as a digital word, that may be input into digital control circuitry 310. Digital control circuitry 310 may contain one or more tables that correlate desired power levels for TCAS transmissions and the Vgs drive voltages for each high power amplifier 324-330 to obtain such a desired power levels. Thus, given a desired output power, digital control circuitry 310 may set forth appropriate combinations of drive voltages for each high power amplifier 324-330 to achieve the desired power output. In addition to providing precise power control for TCAS transmissions, this feedback may be used to monitor and correct the output power, should there be any degradation or drift over time.

The foregoing and following embodiments of the present invention provide many advantages over current TCAS transmitters. First, there is a significant parts count reduction by the elimination of the resistive attenuator approach of the prior art. For example, the PIN diodes, the associated driver circuitry and all the high power resistors used in prior art attenuators are no longer required. This results in a cost reduction due to the elimination of such components, as well as a reduction in PWB (Printed Wiring Board) space required. Furthermore, prior art TCAS transmitters required tuning the resistive attenuators to achieve the level of precision required, unlike embodiments of the present invention, since they obviate the need for such attenuators. In contrast, embodiments of the present invention improve over the prior art at least in part by providing feedback control; automatically selecting amplifier biasing values to drive the desired output power levels, without overdriving and wasting energy; and monitoring the output power levels to adjust, as necessary, the biasing values to continue to drive the desired output levels.

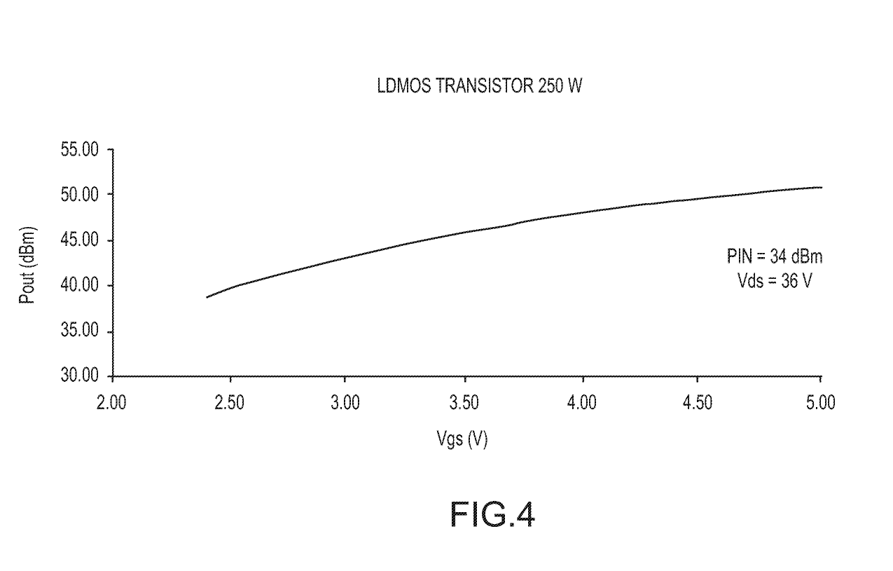

FIG. 4 shows a plot of power out Pout as a function of Vgs for a linear transistor, which in this example is a 250 Watt LDMOS transistor, such as transistor 328 or 330 in FIG. 3. As shown in FIG. 4, the input power is held constant, and the Vgs drive level is varied to control the output power. The plot shows substantial linearity of the output power, as controlled by Vgs. This plot shows that when the input power is fixed, the Vgs DC input voltage can control the device gain and thus the output power level. In the embodiment of TCAS transmitter 300, there are three stages of LDMOS transistors (i.e., transistor 324 (1^{st} stage), transistor 326 (2^{nd} stage) and transistors 328 and 330 (3^{rd} stage)) that are all capable of operating in this manner, thus increasing the dynamic range of controllable output power. If each stage can contribute over 10 dB of dynamic range (as they can), the three stages together can provide at least the 27 dB of dynamic range that TCAS may require for operation, such as when operating the whisper shout scheme.

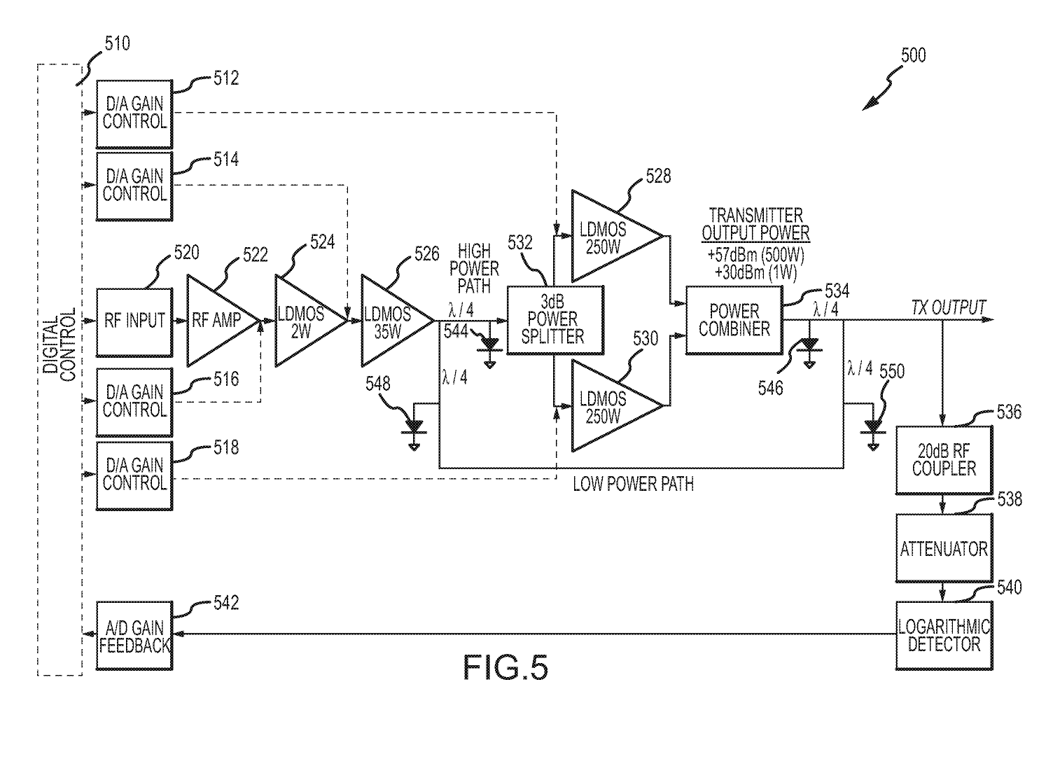

FIG. 5 shows a block diagram of another embodiment of a TCAS transmitter 500, consistent with systems and methods of the present invention. TCAS transmitter 500 is identical to TCAS transmitter 300, as shown in FIG. 3, with the addition of means to select either a high power path or a low power path. Thus, Vgs controllers 312-318 could alternatively be referred to as digital-to-analog gain controllers (like 512-518 in FIG. 5). Similarly, the output power feedback system 342 of FIG. 3 could alternatively be referred to as an analog-to-digital gain feedback system (like 542 in FIG. 5).

TCAS transmitter 500 may include digital control circuitry 510, Vgs gain controllers 512-518, an RF input 520, an RF amplifier 522, high power amplifiers 524-530, a power splitter 532, a power combiner 534, an RF coupler 536, an attenuator 538, a logarithmic detector 540 and an output power feedback system 542. Additionally, TCAS transmitter 500 may include means to select either a high power path or a low power path.

The alternative embodiment TCAS transmitter 500, as shown in FIG. 5, offers even greater output power dynamic range than does TCAS transmitter 300, as shown in FIG. 3. TCAS transmitter 500 includes any desired means to select either a high power path or a low power path. For example, transmitter 500 may include a bypass path that uses PIN diodes 544-550 to direct power through or around the final amplifiers 528 and 530, as shown in FIG. 5. For higher power level transmissions, the signals are directed through the final amplifiers (i.e., amplifiers 528 and 530) by the proper biasing of PIN diodes 544-550 (i.e., blocking the bypass path around amplifiers 528 and 530 and enabling the path through amplifiers 528 and 530). For transmissions requiring less power, the signals are directed around to bypass the final amplifiers 528 and 530, by the proper biasing of PIN diodes 544-550 (i.e., enabling the bypass path around amplifiers 528 and 530 and disabling the path through amplifiers 528 and 530). This dual path approach allows for even greater savings in power consumption and dissipation, particularly when the final amplifiers 528 and 530 are not required to be enabled.

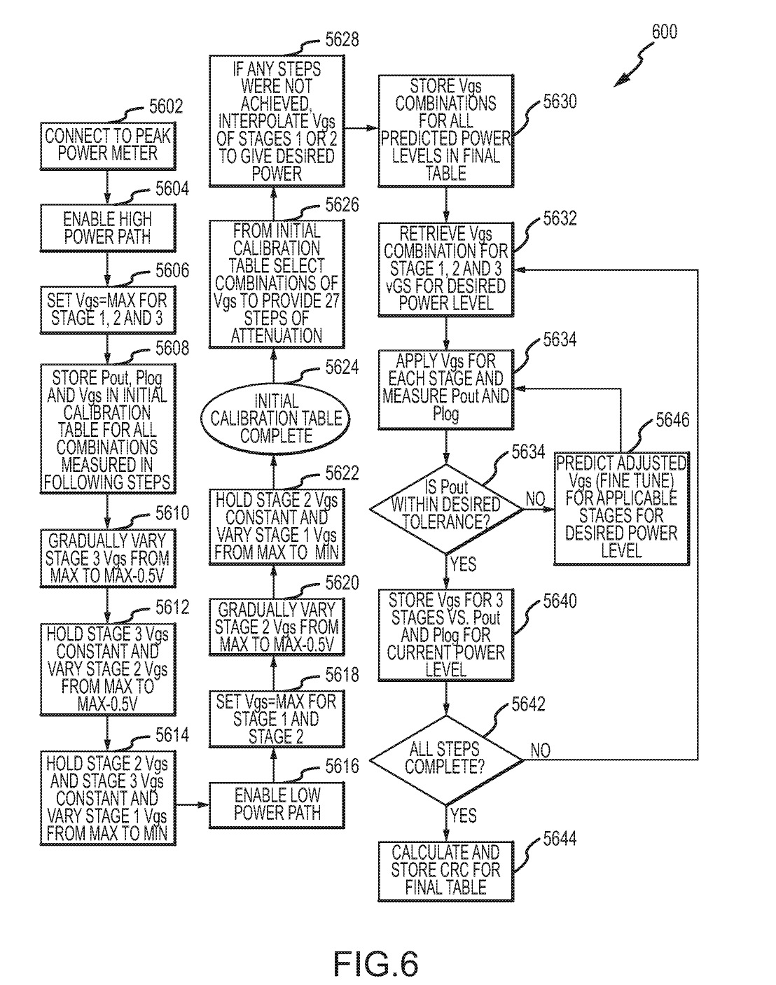

Referring to FIG. 6, an embodiment of a process 600 is shown for initializing a TCAS transmitter, such as TCAS transmitter 300, 500 or any other TCAS transmitter consistent with the present invention. For purposes of description, process 600 is described below with reference to TCAS transmitter 500, however, those with ordinary skill in the art understand that a similar process may be employed for TCAS transmitter 300 or any other TCAS transmitter consistent with the present invention.

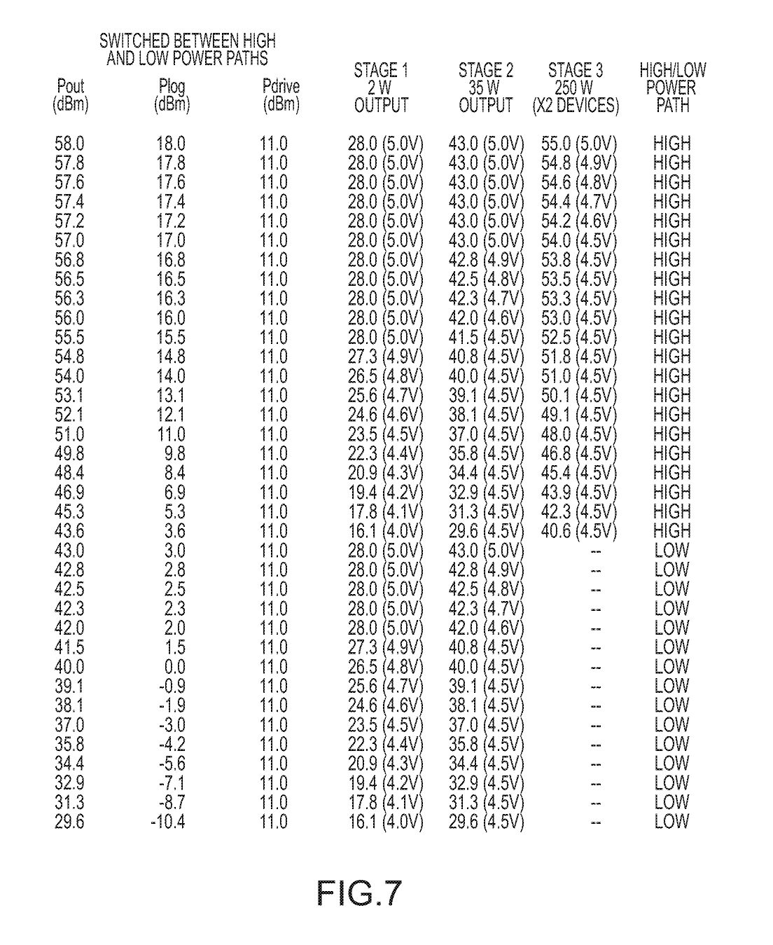

In general, process 600 identifies the peak power output available by applying the maximum Vgs to each stage of amplifiers in TCAS transmitter 500 (i.e., amplifier 524 (1^{st} stage), amplifier 526 (2^{nd} stage) and amplifiers 528 and 530 (3^{rd} stage)). The Vgs values are systematically reduced, one stage at a time, while monitoring output power from TCAS transmitter 500 (i.e., power output from power combiner 534) and power detected by the internal power monitoring circuitry (i.e., power output from logarithmic detector 540). For clarification, when referring herein and throughout this application to measuring power output from the TCAS transmitter (i.e., power output from power combiner 534), as a practical matter, one with skill in the art understands that this actually means measuring output power from the back end of a TCAS unit, including the TCAS transmitter. This also applies to the data in Tables 1 and 2, described below, namely that the power Pout in both tables is actually measured at the back end of a TCAS unit, including the TCAS transmitter. A calibration matrix of Vgs values versus output power Pout and internally detected power Plog is populated with these initial inputs, and an exemplary table of such values is shown in FIG. 7 (hereafter “Table 1”). Table 1 shows an exemplary set of Vgs voltages that may be used for the calibration process.

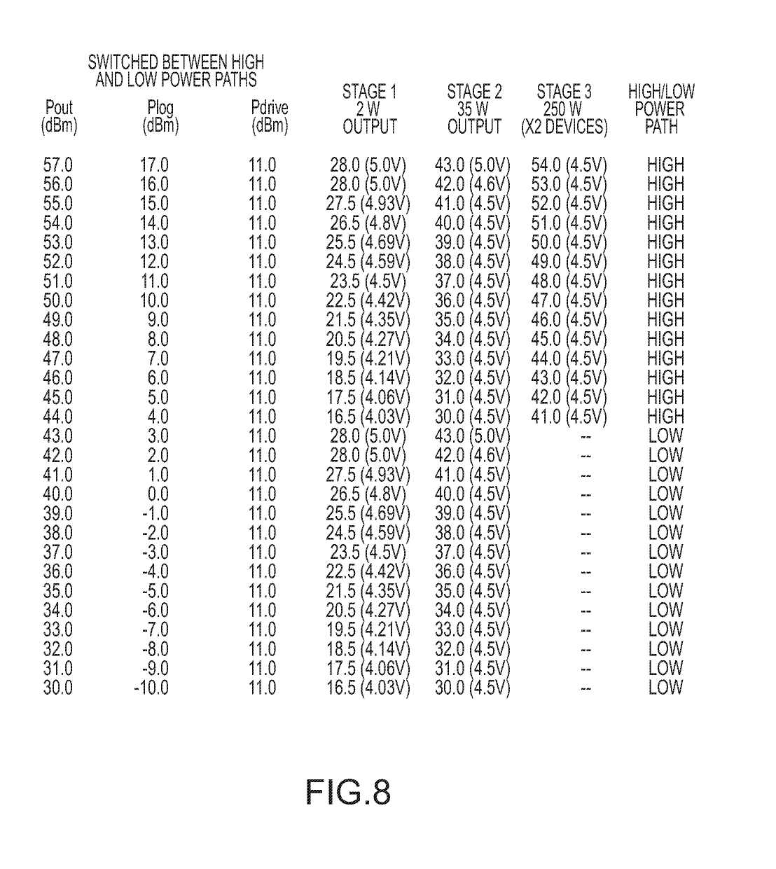

FIG. 8 (hereafter “Table 2”) is an exemplary table of working data for use with a TCAS transmitter, such as TCAS transmitter 300, 500 or any other TCAS transmitter consistent with the present invention. The table of working data in Table 2 may be created based on the data in Table 1 and a series of desired output power levels Pout for TCAS transmitter 500, such as may be required for the whisper shout scheme. For example, in the whisper shout scheme, starting with a desired peak output power Pout, such as 57.0 dBm, as shown in the top entry of Table 2 under the heading “Pout”, each subsequent whisper shout power level is reduced 1 dB below the previous Pout power level, from 57.0 dBm to 30.0 dBm. Predicted sets of Vgs values to give the desired power output levels Pout for each whisper shout step are interpolated from the calibration matrix of initial values in Table 1. Then, these predicted sets of Vgs values are tested to see how well they work in generating the desired output power levels Pout for each whisper shout power level. Such testing involves applying these predicted Vgs values, monitoring output power Pout and comparing the monitored output power Pout with the desired output power Pout to see if the monitored output power Pout is within an acceptable tolerance from the desired output power Pout. If monitored output power Pout is within an acceptable tolerance from the desired output power Pout for a given desired output power Pout, then process 600 moves to test the next power level in the sequence. If, however, the power level is not within tolerance, the Vgs values are adjusted slightly until the power level is confirmed to be within tolerance. This process is continued until all steps have been verified at which time the final table of working data, such as Table 2, is stored in memory.

Still referring to FIG. 6, process 600 is more specifically described below.

In step S602, a power meter is coupled to the output of power coupler 534 to measure output power from TCAS transmitter 500. As noted above, output power is measured from the back end of a TCAS unit, including the TCAS transmitter, so the power meter would be coupled to the back end of the TCAS unit.

In step S604, the high power path of TCAS transmitter 500 is enabled, meaning PIN diodes 544 and 546 are set to enable power flow through power splitter 532 and its downstream circuitry, while PIN diodes 548 and 550 are set to prevent bypassing the high power path of stage 3 amplifiers 528 and 530.

In step S606, maximum power is initially set, meaning Vgs is set to maximum for each of the three stages of amplifiers.

In step S608, process 600 stores power Pout and power Plog, each as a function of different sets of Vgs for the amplifier stages. In other words, and as set forth below in more detail, Vgs is systematically altered for each amplifier stage, and power Pout and power Plog are recorded as a function of the various Vgs sets, resulting in an initial calibration table, such as Table 1. For example, the first or top entry of Table 1 shows in parenthesis that a maximum voltage, e.g., 5.0 V, is set for Vgs in each of the three stages of amplifiers. So driven, power Pout is measured as 58.0 dBm (output from power combiner 534)), power Plog is measured as 18.0 dBm (output from logarithmic detector 540), power Pdrive is 11.0 dBm (output from RF amplifier 522), stage 1 output power is 28.0 dBm (output from amplifier 524), stage 2 output power is 43.0 dBm (output from amplifier 526) and stage 3 output power is 55.0 dBm (output from amplifiers 528 and 530).

In step S610, Vgs for the stage 3 amplifiers 528 and 530 is sequentially varied from a maximum value to a lower value, e.g., from maximum voltage (which is 5.0 volts in this example) to maximum voltage minus 0.5 volts (which is 4.5 volts in this example). For example, Table 1 shows that Vgs (shown in the top six entries in parenthesis under the “stage 3” heading) is sequentially varied from 5.0 volts to 4.5 volts in 0.1 volt increments. Process 600 stores power Pout and power Plog, as a function of the different sets of Vgs for the amplifier stages.

In step S612, while Vgs for the stage 3 amplifiers 528 and 530 is held constant (at a minimum value, e.g. 4.5 volts), Vgs for the stage 2 amplifier 526 is sequentially varied from a maximum value to a lower value, e.g., from maximum voltage (which is 5.0 volts in this example) to the maximum voltage minus 0.5 volts (which is 4.5 volts in this example). For example, Table 1 shows that Vgs (shown in the next consecutive group of six entries in parenthesis under the “stage 2” heading) is sequentially varied from 5.0 volts to 4.5 volts in 0.1 volt increments. Process 600 stores power Pout and power Plog as a function of the different sets of Vgs for the amplifier stages.

In step S614, while Vgs for the stage 3 amplifiers 528 and 530 and the stage 2 amplifier 526 is held constant (at a minimum value, e.g. 4.5 volts), Vgs for the stage 1 amplifier 524 is sequentially varied from a maximum value to a lower value, e.g., from maximum voltage (which is 5.0 volts in this example) to maximum voltage minus 1.0 volts (which is 4.0 volts in this example). For example, Table 1 shows that Vgs (shown in the next consecutive group of 11 entries in parenthesis under the “stage 1” heading) is sequentially varied from 5.0 volts to 4.0 volts in 0.1 volt increments. Process 600 stores power Pout and power Plog as a function of the different sets of Vgs for the amplifier stages.

Up to this point, the high power path is enabled, as represented by “high” in the right-most column of Table 1. Then, in step S616, the low power path of TCAS transmitter 500 is enabled, meaning PIN diodes 544 and 546 are set to disallow power flow through power splitter 532 and its downstream circuitry, while PIN diodes 548 and 550 are set to enable bypassing the high power path of stage 3 amplifiers 528 and 530. Hereafter, the low power path is enabled, as represented by “low” in the remaining entries in the right-most column of Table 1 (for these remaining entries in Table 1, there is no data under the “stage 3” heading, because stage 3, the high power path, is disabled).

In step S618, maximum power is initially set, meaning Vgs is set to maximum for each of the stage 1 and stage 2 amplifiers 524 and 526, respectively.

In step S620, Vgs for the stage 2 amplifier 526 is sequentially varied from a maximum value to a lower value, e.g., from maximum voltage (which is 5.0 volts in this example) to maximum voltage minus 0.5 volts (which is 4.5 volts in this example). For example, Table 1 shows that Vgs (shown in the next six consecutive entries in parenthesis under the “stage 2” heading) is sequentially varied from 5.0 volts to 4.5 volts in 0.1 volt increments. During this time, Vgs for stage 1 amplifier 524 is held constant. Process 600 stores power Pout and power Plog as a function of the different sets of Vgs for the amplifier stages.

In step S622, while Vgs for the stage 2 amplifier 526 is held constant (at a minimum value, e.g. 4.5 volts), Vgs for the stage 1 amplifier 524 is sequentially varied from a maximum value to a lower value, e.g., from maximum voltage (which is 5.0 volts in this example) to the maximum voltage minus 1.0 volts (which is 4.0 volts in this example). For example, Table 1 shows that Vgs (shown in the next consecutive group of 11 entries in parenthesis under the “stage 1” heading) is sequentially varied from 5.0 volts to 4.0 volts in 0.1 volt increments. Process 600 stores power Pout and power Plog as a function of the different sets of Vgs for the amplifier stages.

In step S624, process 600 has stored in memory power Pout and power Plog as a function of the different sets of Vgs set forth above for the amplifier stages. Any type of memory may store this initial calibration data, such as that exemplified by Table 1. Moreover such data may be stored anywhere within or outside of a TCAS transmitter, such as TCAS transmitter 500. For example, such data may be stored in memory within or accessible by digital control circuitry 510.

In step S626, process 600 employs the initial calibration data, such as the exemplary data found in Table 1, to identify different Vgs combinations to provide a predefined number of steps for the whisper shout scheme. For example, Table 2 shows for power Pout 27 steps of 1 dB each from 57.0 dBm to 30 dBm. Accordingly, process 600 employs the initial calibration data, such as the exemplary data found in Table 1, to identify different Vgs combinations to provide these 27 steps for the whisper shout scheme.

In step S628, process 600 determines if any of the initial calibration data includes the desired power Pout level. For example, Table 1 includes data for a power level Pout of 57.0 dBm, which matches the first entry for power level Pout in Table 2. Accordingly, the data from Table 1 for this matching power level Pout may be employed in Table 2, i.e., the Vgs values from Table 1 for the power level Pout of 57.0 dBm may be used in Table 2. For other power levels Pout in Table 2 for which there is no match from the initial calibration data of Table 1, process 600 interpolates to determine power Plog and Vgs values. For example, the next Pout power level in Table 2 is 56.0 dBm, which is also found in the initial calibration data of Table 1, so it can be used directly in the working data of Table 2. The next Pout power level in Table 2 is 55.0 dBm, which is not found in the initial calibration data of Table 1, but it can be determined indirectly by interpolating data in Table 1, such as the data for Pout power levels 55.5 dBm and 54.8 dBm. Such interpolated data for power Plog and the Vgs values may then be included in the working data of Table 2.

In step S630, process 600 has completed identifying in or interpolating from the initial calibration data of Table 1 the working data for storage in a working data table, such as Table 2.

In steps S632 and S634, process 600 retrieves from the working data of Table 2 each Vgs combination and applies the same for testing.

In step S636, process 600 determines for each Vgs combination whether power Pout is within a desired tolerance. If not, the process 600 in step S646 conventionally adjusts Vgs values to “fine tune” the Vgs combination for the “failed” test, so that the revised Vgs values can be retested in a subsequent execution of steps S634 and S636. If in step S636, process 600 determines, based on working data in Table 2, that for a given Vgs combination power Pout is within a desired tolerance, then in step S640 process 600 stores power Pout, power Plog and the Vgs combination.

In step S642, process 600 determines whether all power levels Pout have been tested to build a table of working data within defined tolerance limits. If not, process 600 transitions to step S632 to run the sequence until complete.

In step S644, process 600 stores in memory the final working data, such as the exemplary data shown in Table 2. As part of this step, process 600 may conventionally compute a CRC (Cyclically Redundancy Check). The final working data need not include power Pout, power Pdrive or any indication of Hi/Low power path. In other words, the final working data of Table 2 needed for operation is power Plog and the biasing voltages Vgs. Any type of memory may store the working data, such as that exemplified by Table 2. Moreover such data may be stored anywhere within or outside of a TCAS transmitter, such as TCAS transmitter 500. For example, such data may be stored in memory within or accessible by digital control circuitry 510.

Those with ordinary skill in the art understand that the functionality of process 600 may be programmed conventionally, stored in any memory located anywhere and executed by any type of processor to perform such functionality. Ideally, process 600 is performed before installation on an aircraft, but it could alternatively be performed on an installed TCAS, i.e., installed on an aircraft. Those skilled in the art understand that variations of process 600 may be utilized, without departing from the scope of the present invention. For example, and without limitation, process 600, as described above in exemplary fashion, builds initial calibration data and working data tables from an analysis going from high power to low power, though such building order could be reversed or performed partially from high to low or from low to high or any combinations thereof.

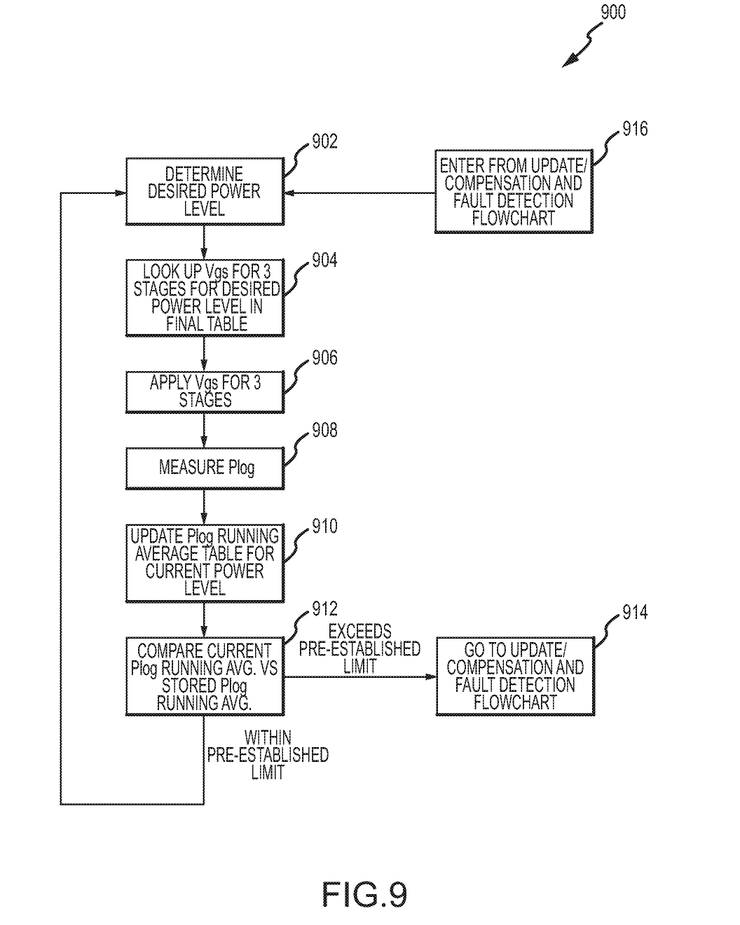

FIG. 9 is a block diagram of an embodiment of a process 900 for selecting output power for a TCAS transmitter, such as TCAS transmitter 300, 500 or any other TCAS transmitter consistent with the present invention. For purposes of description, process 900 is described below in the context of use with TCAS transmitter 500.

In step S902, process 900 determines a desired power level for TCAS transmitter 500 to transmit. In the context of TCAS transmitter 500 transmitting in a whisper shout mode, the power levels Pout for transmission and the sequence of transmission are governed by the whisper shout scheme, which is well known. Accordingly, process 900 would access working data for the whisper shout scheme, as exemplified by the data in Table 2, to obtain the desired power Pout. Again, what constitutes the “desired” power Pout for whisper shout is well known and would be built into process 900 or provided to process 900, so that the desired power Pout is accessed from the working data in Table 2.

In step S904, with a known “desired” power level for Pout, process 900 accesses the whisper shout working data, as exemplified in Table 2, to obtain Vgs drive values corresponding to the “desired” power level for Pout. For example, in Table 2, for a Pout of 57.0 dBm, the stage 1, 2 and 3 Vgs levels are 5.0V, 5.0V and 4.5V, respectively.

In step S906, process 900 applies the obtained Vgs drive values. More specifically, digital control circuitry 510 sends signals to each of D/A gain controls 512-518, so that D/A gain controls 512-518 provide the obtained Vgs drive values to respective amplifiers 528, 526, 524 and 530, thereby driving the “desired” power level for Pout.

In step S908, process 900 measures power Plog based on the “desired” power Pout obtained as a result of the selected Vgs drive values.

In step S910, process 900 updates a running average of power Plog with the power Plog obtained in step S908. More precisely, process 900 maintains a running average of power Plog for each different power Pout that is for use in the whisper shout scheme. Accordingly, process 900 maintains for each power level Pout in Table 2, i.e., 57.0, 56.0 . . . 30.0, a running average of the corresponding power Plog. Additionally, process 900 maintains for each power level Pout in Table 2 a stored Plog value corresponding to each running average of power Plog (the initial stored Plog value is created when Table 2 is created, however, as discussed below, the stored Plog value may be updated based on a running average of Plog).

In step S912, process 900 compares (a) the current running average of power Plog corresponding to the last-measured power Plog with (b) the corresponding stored value for power Plog. If process 900 determines that the current running average of power Plog corresponding to the last-measured power Plog is within established limits from the corresponding stored value for power Plog, process 900 returns to step S902. However, if process 900 determines that the current running average of power Plog corresponding to the last-measured power Plog is not within established limits from the corresponding stored value for power Plog, process 900 moves to step S914, to enable fault detection and compensation processes.

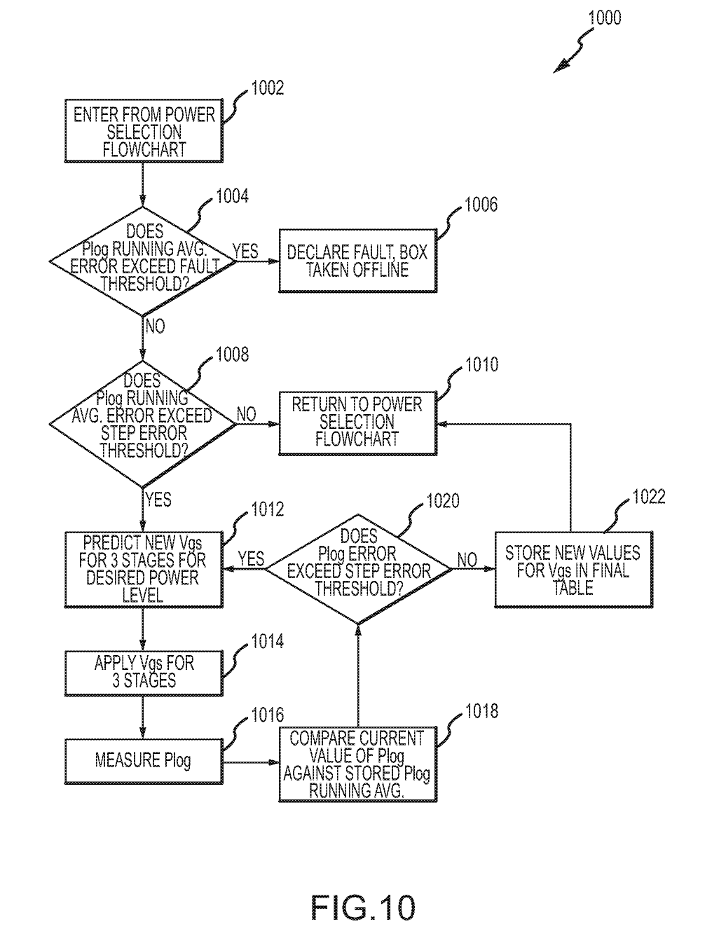

FIG. 10 is a block diagram of an embodiment of a process 1000 for compensating output power for a TCAS transmitter, such as TCAS transmitter 300, 500 or any other TCAS transmitter consistent with the present invention. For purposes of description, process 1000 is described below in the context of use with TCAS transmitter 500.

Process 1000 may be used to compensate for any variation in performance of TCAS transmitter 500. For example, process 1000 may be used to compensate for cyclical variation, such as temperature cycling, as well as long-term adjustment due to system aging or degradation in system performance. Process 1000 may also be used to determine whether a variation in detected power level is indicative of a serious fault, perhaps meriting system shut down, or because of variations that are correctable during system operation.

In step S1002, process 1000 initiates, having been triggered by step S914 in process 900.

In step S1004, process 1000 determines whether the current running average of power Plog corresponding to the last-measured power Plog (i.e., as last determined in step S910 in process 900) exceeds a stored corresponding Plog value (i.e., Plog in Table 2) by more than some predefined fault detection threshold. The fault detection threshold may be a value above or a value below a target value. For example, if the current running average of power Plog corresponding to the last-measured power Plog exceeds a stored corresponding Plog value (i.e., Plog in Table 2) by more than some predefined fault detection threshold, a fault has been detected, and process 1000, therefore, passes to step S1006 from which the fault is declared (i.e., a report is generated and reported to a user). As such, the user is made aware of the system fault and may shut down or ignore the affected system, or alternatively, the affected system may shut down automatically.

Assuming that a fault is not detected in step S1004, then in step S1008, process 1000 determines whether a running average of power Plog, as compared to another running average for the next consecutive Plog, exceeds an error detection threshold. Here, “next consecutive” means the table entry preceding or following a running average of a power Plog in a sequential listing of running averages of power Plog. The error detection threshold may be a value above or a value below a target value. This error detection process runs in the background, meaning the running average of power Plog that is under consideration at a given time is irrespective of the power level actually being transmitted at the time. In this way, Plog corrections can be made in an ongoing basis. For example, if the running average of power Plog, as compared to the running average of the next consecutive (up or down) power Plog, exceeds a predefined error detection threshold, a system error has been detected, and process 1000, therefore, passes to step S1012 where a compensation sequence is initiated. If, however, no system error is detected in step S1008, process 1000 passes to step S1010, which returns to process 900 at step S916.

In step S1012, process 1000 predicts new (corrected) Vgs values for the power level Pout corresponding to the running average of power Plog which triggered this correction or compensation sequence. In the testing of step S1008, process 1000 essentially compares two consecutive running averages for power Plog and determines if the difference between them exceeds some predefined error threshold. If so, then one or both of the running averages of power Plog may have contributed to the error. To determine which is erroneous, process 1000 may look at each of the two consecutive running averages for power Plog and compare each to their respective stored value for power Plog, identifying the one with the larger difference between running average and stored value as the offending entry. Then, process 1000 initiates compensation of the offending entry, as described below (of course, if desired, both entries may be compensated in any order).

Any conventional prediction scheme may be employed to “fine tune” or adjust Vgs values, analogous to step S646 in process 600. For example, to “fine tune,” process 1000 would not start by adjusting the Vgs gain of the larger amplifiers 528 and 530, instead opting to incrementally adjust the Vgs gain of the smallest amplifier 524, to see if that corrects the error (and if not, systematically adjusting the Vgs gain for the smallest amplifier 524 until a full range of adjustment has been completed, without correction of the error, at which time adjustment of the larger amplifiers 526, 528 and/or 530 may be employed, individually or collectively).

In step S1014, process 1000 tests the adjusted Vgs values determined in step S1012 by applying the same and then measuring power Plog in step S1016. In an exemplary embodiment, one set of adjusted Vgs values is tested at a time (i.e., if one set fails, as determined in steps S1018 and S1020, then the next set of “fine tune” adjustments is tested).

In step S1018, process 1000 compares the measured value of Plog, which is based on the last set of adjusted Vgs values from step S1016, against the stored value of Plog corresponding to the erroneous Plog value. This results in a computed error for Plog.

In step S1020, if process 1000 determines that the computed Plog error from step S1018 exceeds an error threshold, then process 1000 passes to step 1012 to obtain new predicted Vgs values for similar testing until passing the test of step S1020. Once process 1000 determines that the computed Plog error from step S1018 falls within the error threshold, then process 1000 passes to step 1022.

In step S1022, once the Vgs adjustment has passed the testing of step S1020, process 1000 accesses the working data, as exemplified in Table 2, and updates the same. For example, for the subject power level Pout under adjustment, the newly-determined Vgs values (as determined in steps S1012-1020) will replace their corresponding Vgs values in Table 2. Additionally, the corresponding value for Plog in Table 2 is updated with the measured Plog from step S1016, using the Vgs values that resulted in passing the test of step S1020. This value of power Plog will constitute a “new” stored value for power Plog and the corresponding running average of power Plog will be reset to match this value, thereafter evolving as the running average is built with new power Plog entries.

Those with ordinary skill in the art understand that the functionality of processes 900 and 1000 may be programmed conventionally, stored in any memory located anywhere and executed by any type of processor to perform such functionality. For example, such memory and processor may be located within or accessible by digital control circuitry 510. Additionally, processes 900 and 1000, as described above, employ running averages of power Plog for testing, so that a one-time spurious measurement of power Plog will not trigger a nuisance failure. Nevertheless, either or both processes 900 or 1000 could base testing on individual measurements of power Plog, instead of running averages of the same.

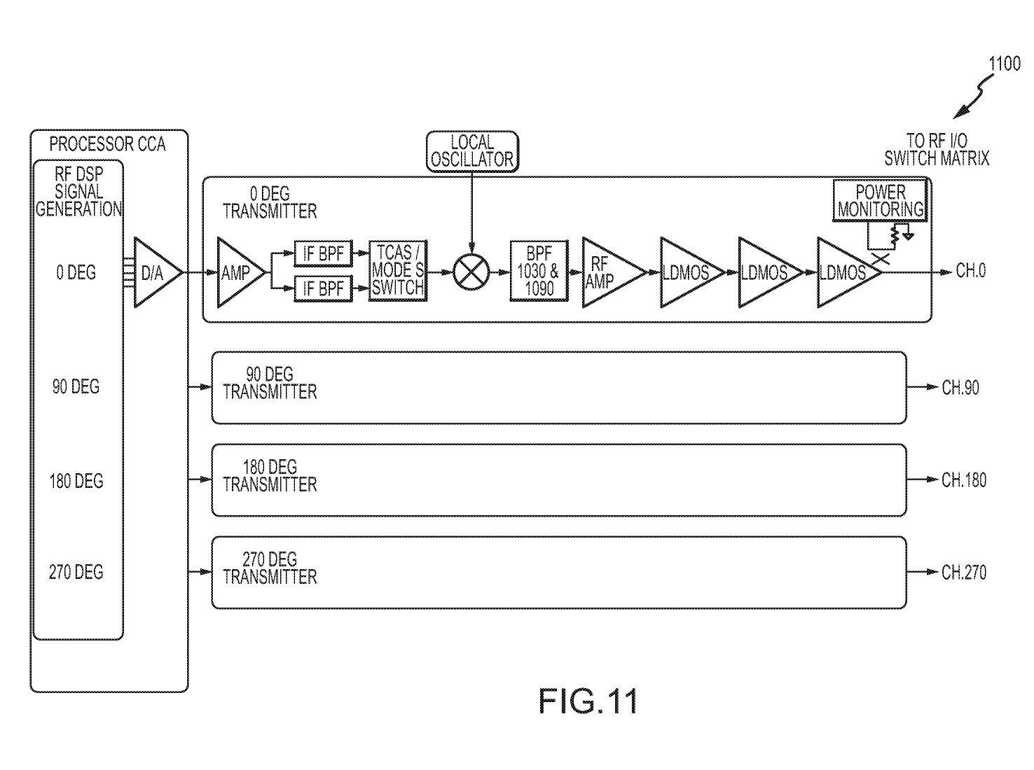

FIG. 11 is a block diagram of another embodiment of a TCAS transmitter 1100, in accordance with systems and methods consistent with the present invention. In addition to the precision amplitude control required by the whisper shout scheme, amplitude control on multiple transmitter channels, such as channels Ch. 0, Ch. 90, Ch. 180 and Ch. 270 (as shown in FIG. 11), is also required to ensure that an antenna radiation pattern can be made omnidirectional, if desired. Accordingly, TCAS transmitter 1100 may have four identical transmitter lineups to output equal phase, equal power level signals to the antenna to accomplish an omnidirectional antenna pattern. In this case, the amplitude control mechanism of each channel Ch. 0, Ch. 90, Ch. 180 and Ch. 270 may be used to balance the power output of the four channels. Further, each channel Ch. 0, Ch. 90, Ch. 180 and Ch. 270 may have its own table of Vgs values vs. power Pout and power Plog to accomplish the whisper shout scheme, as set forth above.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, a TCAS must be able to transmit at least 27 different levels of output power, assuming the TCAS is a TCAS II unit, however, those skilled in the art understand that various other collision avoidance systems, such as a TCAS I, may require a different number of stepped power levels for whisper shout operation.

What is claimed is:

1. A collision avoidance system, comprising:
a TCAS transmitter having a feed forward path with a plurality of amplifiers for providing to a TCAS transmitter output a TCAS transmitter output transmission;
a feedback path coupled to the TCAS transmitter output for providing a feedback signal; and
a controller for receiving the feedback signal and generating control signals for providing to one or more of the plurality of amplifiers for controlling the respective outputs of the one or more amplifiers to drive the TCAS transmitter output transmission to a predefined level.

2. The system of claim 1 wherein the plurality of amplifiers comprise class AB amplifiers.

3. The system of claim 1 wherein the plurality of amplifiers comprise LDMOS amplifiers.

4. The system of claim 1 wherein the predefined level corresponds to a power output level for a TCAS transmission during a whisper shout operation.

5. The system of claim 1 wherein the controller controls the driving of the output transmission to a predefined level such that attenuators are not required to reduce from a level above the predefined level down to the predefined level.

6. The system of claim 1 further including a table of data for use in a whisper shout operation.

7. The system of claim 6 wherein the table of data is stored in memory in the controller.

8. The system of claim 6 wherein the table includes a plurality of entries, each entry corresponding to a different power level for whisper shout operation and each entry including at least one power level and a plurality of biasing voltages for the plurality of amplifiers.

9. The system of claim 8 further including a process for determining when any of the plurality of biasing voltages should be updated and when required updating the plurality of biasing voltages.

10. A method of operating a TCAS for a whisper shout operation, comprising:
providing signals to bias a plurality of amplifiers to provide on a TCAS transmitter output a TCAS transmission of a predefined power level for whisper shout operation; and
adjusting the signals for biasing the plurality of amplifiers based on a measurement of the predefined power level for whisper shout operation.

11. The method of claim 10 further including feeding back a portion of the predefined power level for whisper shout operation.

12. The method of claim 10 wherein the plurality of amplifiers comprise class AB amplifiers.

13. The method of claim 10 wherein the plurality of amplifiers comprise LDMOS amplifiers.

14. The method of claim 10 further including providing a table of data for use in a whisper shout operation.

15. The method of claim 14 wherein the table of data is stored in memory in the TCAS.

16. The method of claim 14 wherein the table includes a plurality of entries, each entry corresponding to a different power level for whisper shout operation and each entry including at least one power level and a plurality of biasing voltages for the plurality of amplifiers.

17. The method of claim 16 further including determining when any of the plurality of biasing voltages should be updated and when required updating the plurality of biasing voltages.

18. The method of claim 16 further including determining when operation of the TCAS merits shutting down further operation of the TCAS.
